(19) United States
(12) Patent Application Publication
(10) Pub. No.: US 2022/0305588 A1
(43) Pub. Date: Sep. 29, 2022

(54) METHODS TO DICE OPTICAL DEVICES WITH OPTIMIZATION OF LASER PULSE SPATIAL DISTRIBUTION

(71) Applicant: Applied Materials, Inc., Santa Clara, CA (US)

(72) Inventors: Wei-Sheng LEI, San Jose, CA (US); Mahendran Chidambaram, Santa Clara, CA (US); Kangkang Wang, San Jose, CA (US); Ludovic Godet, Sunnyvale, CA (US); Visweswaren Sivaramakrishnan, Cupertino, CA (US)

(21) Appl. No.: 17/655,629

(22) Filed: Mar. 21, 2022

Related U.S. Application Data
(60) Provisional application No. 63/165,568, filed on Mar. 24, 2021.

(51) Int. Cl. B23K 26/364; B23K 26/40; B23K 26/38

(52) U.S. Cl. CPC B23K 26/364; B23K 26/40; B23K 26/38

(57) ABSTRACT

Embodiments of the present disclosure relate to methods for dicing one or more optical devices from a substrate with a laser machining system. The laser machining system utilizes a laser to perform methods for dicing one or more optical devices from a substrate along a dicing path. The methods use one of forming a plurality of laser spots along the dicing path or forming a plurality of trenches along the dicing path.

### CROSS-REFERENCE TO RELATED APPLICATIONS

This application claims benefit of U.S. Provisional Patent Application No. 63/165,568, filed Mar. 24, 2021, which is herein incorporated by reference in its entirety.

### BACKGROUND

### Field

Embodiments of the present disclosure generally relate to optical devices. Specifically, embodiments of the present disclosure relates to methods for dicing one or more optical devices from a substrate with a laser machining system.

### Description of the Related Art

Virtual reality (VR) is generally considered to be a computer generated simulated environment in which a user has an apparent physical presence. A VR experience can be generated in 3D and viewed with a head-mounted display (HMD), such as glasses or other wearable display devices that have near-eye display panels as lenses to display a VR environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhances or augments the environment that the user experiences. In order to achieve an AR experience, a virtual image is overlaid on an ambient environment, with the overlaying performed by optical devices.

Multiple optical devices are fabricated on a substrate and then diced prior to use on VR and AR devices. During conventional methods of dicing one or more optical devices from optically transparent materials such as glass and silicon carbide (SiC) substrates, it is difficult to accurately dice the optical devices from the substrate to retain the quality of the optical devices. The optical devices, generally including high bandgap materials, are brittle and sensitive to thermal or mechanical stresses. Thus, when dicing the substrate, a sudden change of the dicing direction can cause non-symmetrical thermal or mechanical stress distribution in the substrate along the dicing path. The non-sym metrical stress distributions in the substrate leads to cracks or chips, especially with the complex contours utilized with optical devices. The cracks and chips in the optical devices decrease the quality of the optical devices and decrease yield of the optical devices.

Accordingly, there is a need for improved methods of dicing one or more optical devices from a substrate.

### SUMMARY

In one embodiment, a method is provided. The method includes forming a first set of laser spots along a dicing path on a first pass of a laser. The dicing path is disposed around an optical device on a substrate. The method further includes forming a second set of laser spots along the dicing path on a second pass with the laser. The second set of laser spots are formed adjacent to the first set of laser spot. The method further includes forming a third set of laser spots along the dicing path on a third pass with the laser. The third set of laser spots are formed adjacent to the first set of laser spots and the second set of laser spots. The method further includes removing the optical device from the substrate.

In another embodiment, a method is provided. The method includes forming a trench in a first section, a second section, and a third section at a first trench depth. The first trench depth is formed during a first pass of a laser over a dicing path. The dicing path is disposed around an optical device on a substrate. The method further includes performing one or more subsequent passes of the laser over the dicing path to form the trench in the first section, the second section, and the second section at subsequent trench depths until a total trench depth is reached. The method further includes removing the optical device from the substrate.

In yet another embodiment, a non-transitory computer-readable medium is provided. The non-transitory computer-readable medium is storing instructions that, when executed by a processor, cause a computer system to perform the steps of forming a first set of laser spots along a dicing path on a first pass of a laser. The dicing path is disposed around an optical device on a substrate. The steps further include forming a second set of laser spots along the dicing path on a second pass with the laser. The second set of laser spots are formed adjacent to the first set of laser spots. The steps further include forming a third set of laser spots along the dicing path on a third pass with the laser. The third set of laser spots are formed adjacent to the first set of laser spots and the second set of laser spots. The steps further include removing the optical device from the substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, top-view of a substrate according to embodiments.

FIG. 2 is a schematic, cross-sectional view of a laser machining system according to embodiments.

FIG. 3 is a flow diagram of a method for dicing one or more optical devices from a substrate according to embodiments.

FIGS. 4A-4C are schematic, top-views of an optical device of one or more optical devices according to embodiments.

FIG. 5 is a flow diagram of a method for dicing one or more optical devices from a substrate according to embodiments.

FIG. 6A is a schematic, top-view of an optical device of one or more optical devices according to embodiments.

FIG. 6B is a schematic, cross-sectional view of an optical device of one or more optical devices according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. Specifically, embodiments of the present disclosure relates to methods for dicing one or more optical devices from a substrate with a laser machining system.

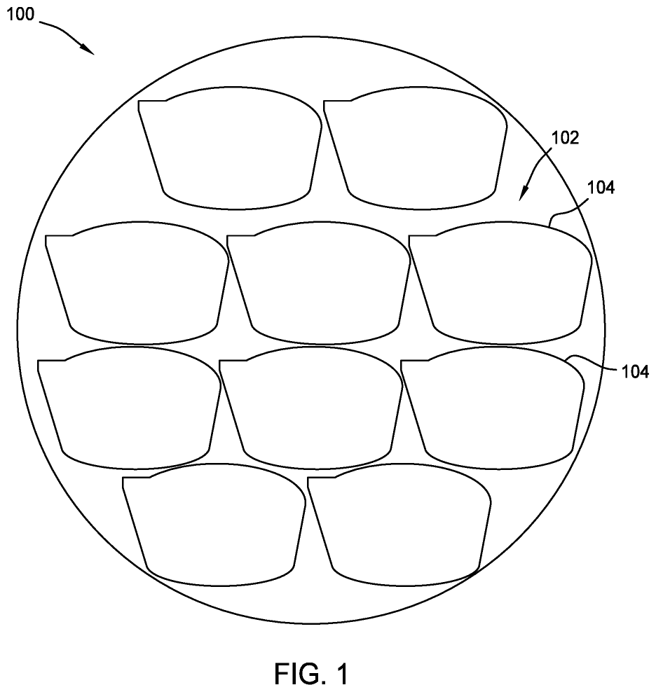

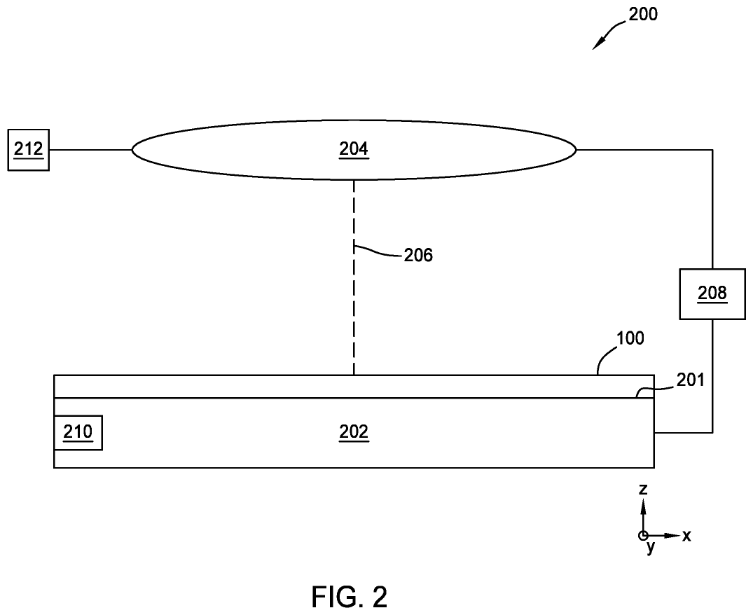

FIG. 1 is a schematic, top-view of a substrate 100. One or more optical devices 102 are disposed on the substrate 100. Each optical device 102 of the one or more optical devices 102 includes a dicing path 104. The dicing path 104 is defined along the exterior edge of each optical device 102. The dicing path 104 is the predetermined dicing path for a laser (shown in FIG. 2) to travel along during the methods 300 and 500 such that the quality of the optical device 102 is maintained during dicing operations. The substrate 100 can be any substrate used in the art, and can be either opaque or transparent to a chosen laser wavelength depending on the use of the substrate 100. It is to be understood that the substrate 100 described below is an exemplary substrate. Although only ten optical devices 102 are shown on the substrate 100, any number of optical devices 102 may be disposed on the substrate 100.

The substrate 100 may be formed from any suitable material, provided that the substrate 100 can adequately transmit or absorb light in a predetermined wavelength or wavelength range and can serve as an adequate support for the one or more optical devices 102. Substrate selection may include any suitable material, including, but not limited to, amorphous dielectrics, crystalline dielectrics, aluminum nitride, silicon oxide, silicon carbide, polyhedral oligomeric silsesquioxane (POSS) and other polymers, and combinations thereof. For example, the substrate 100 includes silicon (Si), silicon dioxide (SiO2), fused silica, quartz, silicon carbide (SiC), germanium (Ge), silicon germanium (SiGe), indium phosphide (InP), gallium arsenide (GaAs), gallium nitride (GaN), sapphire, or combinations thereof. In some embodiments, which can be combined with other embodiments described herein, the substrate 100 includes a transparent material. Suitable examples may include an oxide, sulfide, phosphide, telluride or combinations thereof. Additionally, the substrate 100 may be varying shapes, thicknesses, and diameters. For example, the substrate 100 may have a diameter of about 150 mm to about 300 mm. The substrate 100 may have a circular, rectangular, or square shape. The substrate 100 may have a thickness of between about 300 μm to about 1 mm. Other dimensions are also contemplated.

It is to be understood that the one or more optical devices 102 described herein are exemplary optical devices. In one embodiment, which can be combined with other embodiments described herein, an optical device of the one or more optical devices 102 is a waveguide combiner, such as an augmented reality waveguide combiner. In another embodiment, which can be combined with other embodiments described herein, an optical device of the one or more optical devices 102 is a flat optical device, such as a metasurface.

FIG. 2 is a schematic, cross-sectional view of a laser machining system 200. The laser machining system is utilized in a method 300 and a method 500 for dicing one or more optical devices from a substrate 100 with the laser machining system 200.

The laser machining system 200 includes a substrate 100 disposed on a surface 201 of a stage 202. The stage 202 is disposed in the laser machining system 200 such that the surface 201 of the stage 202 is positioned opposite of a scanner 204. The scanner 204 includes a laser 206. The laser machining system 200 is operable to dice the one or more optical devices 102 from the substrate 100 along the dicing path 104. The laser machining system 200 includes a controller 208. The controller 208 is in communication with the stage 202 and the scanner 204.

The laser machining system 200 is operable to dice one or more optical devices 102 from a substrate 100. In one embodiment, which can be combined with other embodiments described herein, the laser machining system 200 is operable to utilize filamentation to dice the one or more optical devices 102 from the substrate 100. Filamentation includes providing a laser pulse from the laser 206 etching a hole in the substrate 100 through the thickness of the substrate 100 along the dicing path 104 with the laser 206. In another embodiment, which can be combined with other embodiments described herein, the laser machining system 200 is operable to utilize laser ablation to dice the one or more optical devices 102 from the substrate 100. Laser ablation includes etching a trench into the substrate 100 along the dicing path 104 with the laser 206.

The controller 208 is generally designed to facilitate the control and automation of the methods described herein. The controller 208 may be coupled to or in communication with the laser 206, the stage 202, and the scanner 204. The stage 202 and the scanner 204 may provide information to the controller 208 regarding the method 300 and the method 500 and alignment of the substrate 100. The controller 208 may be in communication with or coupled to a CPU (e.g., a computer system). The CPU can be a hardware unit or combination of hardware units capable of executing software applications and processing data. In some configurations, the CPU includes a central processing unit (CPU), a digital signal processor (DSP), an application-specific integrated circuit (ASIC), a graphic processing unit (GPU) and/or a combination of such units. The CPU is generally configured to execute the one or more software applications and process stored media data.

The laser 206 is a pulsed laser. In one embodiment, which can be combined with other embodiments described herein, the laser 206 includes a Gaussian beam profile with a beam quality “M2-factor” of less than about 1.3. In another embodiment, which can be combined with other embodiments described herein, the laser 206 is a Bessel-type beam profile. The laser 206 is in communication with the controller 208. The controller 208 may control other input parameters or output parameters of the laser 206, as described in the method 300 and the method 500.

The stage 202 includes a stage actuator 210. The stage actuator 210 allows the stage 202 to scan in the X direction, the Y direction, and the Z direction, as indicated by the coordinate system shown in FIG. 2. The stage 202 is coupled to the controller 208 in order to provide information of the location of the stage 202 to the controller 208. Additionally, the stage 202 is in communication with the controller 208 such that the stage 202 may move in a direction such that the laser 206 traces the dicing path 104.

The scanner 204 includes a scanner actuator 212. The scanner actuator 212 allows the scanner 204 to scan in the X direction, the Y direction, and the Z direction, as indicated by the coordinate system shown in FIG. 2. The laser 206 is disposed in the scanner 204. The scanner 204 is coupled to the controller 208 in order to provide information of the location of the scanner 204 to the controller 208. Additionally, the scanner 204 is in communication with the controller 208 such that the scanner 204 may move the laser 206 to trace the dicing path 104. In one embodiment, which can be combined with other embodiments described herein, the scanner 204 is a galvo scanner.

In one embodiment, which can be combined with other embodiments described herein, the laser machining system 200 performing methods for dicing one or more optical devices 102 from a substrate 100 may utilize movement of both the scanner 204 and the stage 202 to direct the laser 206 along the dicing path 104. In another embodiment, which can be combined with other embodiments described herein, the laser machining system 200 performing the methods for dicing one or more optical devices 102 from a substrate 100 may utilize only the scanner 204 to direct the laser 206 along the dicing path 104. For example, the scanner 204 moves the laser 206 along the dicing path 104. In yet another embodiment, which can be combined with other embodiments described herein, the laser machining system 200 performing the methods for dicing one or more optical devices 102 from a substrate 100 may utilize only the stage 202 to direct the laser 206 along the dicing path 104. For example, the stage 202 moves such that the laser, which is in a fixed position, moves along the dicing path 104.

In embodiments with a substrate 100 including glass, the scanner 204 and the laser 206 are in a fixed position. The stage 202 is scanned such that the laser 206 moves along the dicing path 104. The laser 206 includes a Bessel type beam profile. The laser 206 is an infrared laser. The wavelength of the laser 206 is about 1 μm. The laser 206 is transparent in the substrate 100 including glass, and thus is able to dice the one or more optical devices 102 of the substrate 100. The laser 206 has a beam width of between about 1 μm and about 10 μm.

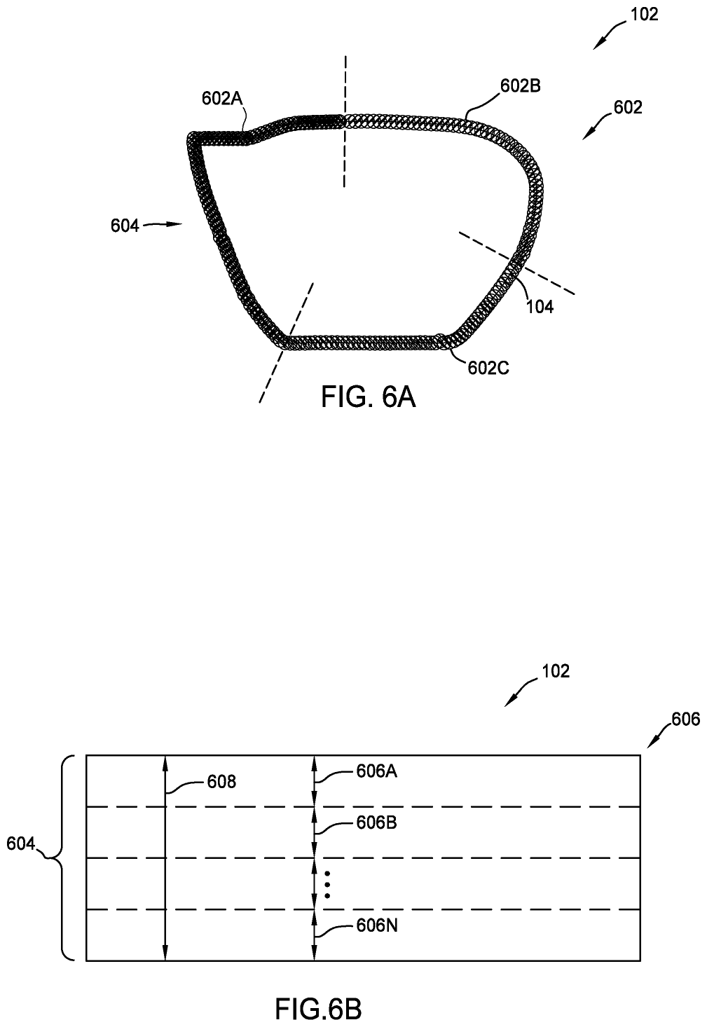

In embodiments with a substrate 100 including silicon carbide, the scanner 204, such as a galvo scanner, is utilized to scan the laser 206 along a plurality of sections (shown in FIG. 6) along the dicing path 104. The stage 202 is utilized to scan the substrate 100 between the plurality of sections such that the laser 206 may move along each section along the dicing path 104. The laser 206 includes a Gaussian type beam profile. The laser 206 is absorptive in the substrate 100 including silicon carbide, and thus is able to dice the one or more optical devices 102 of the substrate 100. The laser 206 has a beam width of between about 10 μm to about 100 μm. The laser 206 may be an infrared laser with a wavelength of about 1 μm and the photon energy of the laser 206 may be about 1.1 eV. The laser 206 may be a green laser with a wavelength between about 500 nm and about 540 nm and the photon energy of the laser 206 may be about 2.5 eV. The laser 206 may be an ultraviolet laser with a wavelength between about 300 nm and about 360 nm and the photon energy of the laser 206 may be about 3.5 eV.

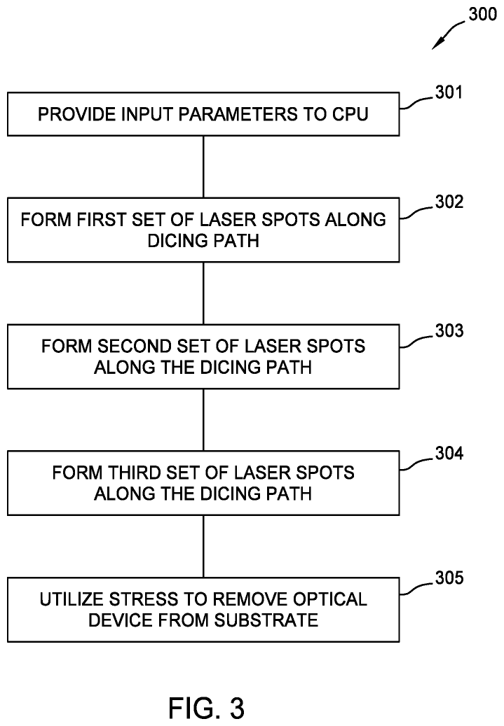

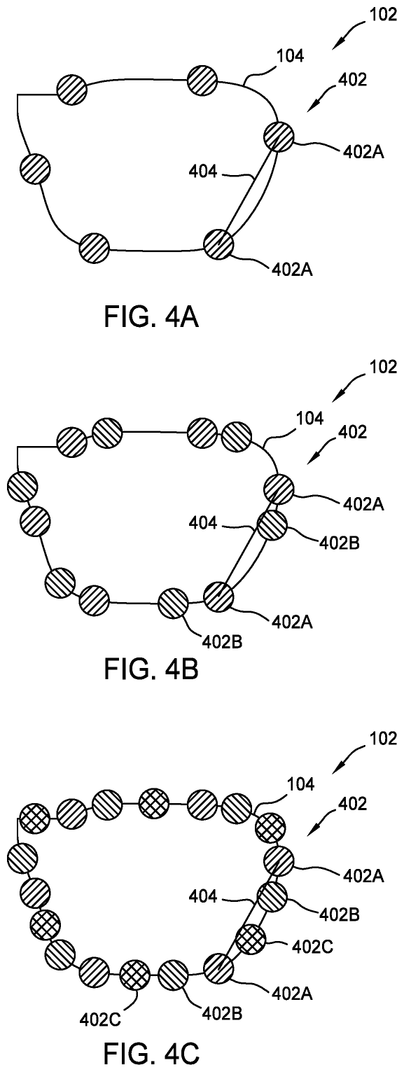

FIG. 3 is a flow diagram of a method 300 for dicing one or more optical devices from a substrate 100. The method 300 utilizes a filamentation process to dice the one or more optical devices 102 of the substrate 100. The method 300 is described with reference to FIGS. 4A-4C. It is also contemplated that any suitable contour of the optical device 102 may be utilized with the method 300 and is not limited to the contour shown in FIGS. 4A-4C. During the method 300, a pass is defined as the laser 206 completely passing over the length of a dicing path 104 of an optical device 102 (e.g., passing along the entire perimeter of the optical device 102). The method 300 is operable to be performed on the substrate 100 including a glass material.

FIGS. 4A-4C are schematic, top-views of an optical device of one or more optical devices 102. To facilitate explanation, the method 300 will be described with reference to laser machining system 200 of FIG. 2. However, it is contemplated that other suitably configured apparatuses other than the laser machining system 200 may be utilized in conjunction with method 300.

The optical device 102, shown in FIGS. 4A-4C, include a plurality of laser spots 402. Each laser spot 402 is formed when a laser pulse from the laser 206 etches a hole in the substrate 100. The plurality of laser spots 402 are disposed along the dicing path 104. The dicing path 104 surrounds the optical device 102 disposed on the substrate 100. The plurality of laser spots 402 are formed through the entire thickness of the substrate 100. The plurality of laser spots 402 are formed along the dicing path 104 such that a thermal and/or mechanical stress field is formed around each laser spot 402. A pitch 404 is defined as the distance between laser spots 402. Each laser spot 402 includes a laser spot diameter defining the dimeter of the hole formed through the substrate. The laser spot diameter is between about between about 1 μm and about 10 μm. The plurality of laser spots 402 shown in FIGS. 4A-4C are not drawn to scale, but are enlarged for ease of explanation.

At operation 301, a user may provide input parameters of the methods for dicing one or more optical devices 102 from the substrate 100 into a CPU in communication with a controller 208. The CPU can be a hardware unit or combination of hardware units capable of executing software applications based on the input parameters. The input parameters include one or more of a laser spot diameter, a stage scanning rate, pulse width, wavelength of the laser 206, the contour of the one or more optical devices 102, laser pulse frequency, pitch 404 in a single pass of the laser 206, dicing speed, or other relevant parameters. The controller 208 will provide output parameters of the methods for dicing one or more optical devices 102 from the substrate 100 including one or more of dicing speed, number of passes, laser pulse frequency, or other relevant parameters to be used in the method 300. The output parameters are determined based on the input parameters. The input parameters and the output parameters are chosen in the method 300 to reduce cracking and chipping of the one or more optical devices 102 during the method 300 and to optimize the stress distribution of the plurality of laser spots 402. Laser power and laser spot size may also be adjusted as needed.

In one embodiment, which can be combined with other embodiments described herein, the contour of the one or more optical devices 102, the laser pulse frequency, and the predetermined pitch 404 in a single pass are input as input parameters. The software application provides output parameters including the dicing speed and number of passes. In another embodiment, which can be combined with other embodiments described herein, the contour of the one or more optical devices 102, the dicing speed, and the predetermined pitch 404 in a single pass are input as input parameters. The software application provides output parameters including laser pulse frequency and the number of passes.

At operation 302, as shown in FIG. 4A, a first set of laser spots 402A are formed on the dicing path 104. The first set of laser spots 402A are formed during a first pass by the laser 206. A stage 202 of a laser machining system 200 is scanned such that the laser 206 moves along the dicing path 104. The laser 206 provides laser pulses to form the plurality of laser spots 402 in the dicing path 104. The operation 302 is performed based on the input parameters and the output parameters.

In embodiments where the laser 206 is a Bessel-type beam profile, the laser 206 has a laser spot diameter of between about 1 μm and about 10 μm. For example, the laser spot diameter is between about 3 μm and about 5 μm. The pitch 404 between adjacent laser spots of the first set of laser spots 402A is between about 3 times and about 10 times greater than the value of the laser spot diameter. The laser 206 pulses during the formation of each laser spot 402. The laser 206 delivers pulses to the work surface at a constant pulse frequency or in a burst mode. When the laser is operated in burst mode, the number of laser pulses within a burst is between about 2 and about 100. For example, the number of laser pulses within a burst is between about 5 and about 10. The laser 206 may have a laser pulse frequency in the range of about 100 kHz to about 5 MHz. For example, between 200 kHz and about 500 kHz. The stage 202 is scanned at a rate of less than about 2 m/s. The laser 206 may have a pulse width of between about 100 fs and about 100 ps. For example, between about 300 fs and about 15 ps. The laser 206 may be an infrared laser. The wavelength of the laser 206 may be 1 μm. The laser 206 may be a Green laser with a wavelength between about 500 nm and about 540 nm. The laser 206 may have a dicing speed of between about 10 mm/s to about 1 m/s. For example, between about 50 mm/s to about 500 mm/s.

The first set of laser spots 402A are formed along the dicing path 104 and are allowed to cool, thus reducing the thermal stress surrounding the first set of laser spots 402A. The pitch 404 between adjacent laser spots of the first set of laser spots 402A in the first pass allows the mechanical stress along the dicing path 104 to be reduced due to less proximity with other laser spots.

At operation 303, as shown in FIG. 4B, a second set of laser spots 402B are formed on the dicing path 104. The second set of laser spots 402B are formed during a second pass by the laser 206. The operation 303 is performed based on the input parameters and the output parameters. The distance between adjacent laser spots of the first set of laser spots 402A and the second set of laser spots 402B is between about 0.5 times and about 1.0 times greater than the value of the laser spot diameter. The pitch 404 between adjacent laser spots of the second set of laser spots 402B is between about 3 times and about 10 times greater than the value of the laser spot diameter.

The second set of laser spots 402B are offset from the first set of laser spots 402A. The third set of laser spots 402C are offset from the first set of laser spots 402A and the second set of laser spots 402B. The second set of laser spots 402B are formed along the dicing path 104 and are allowed to cool, thus reducing the thermal stress surrounding the first set of laser spots 402A and the second set of laser spots 402B. A cooling time between the first pass and the second pass allows the mechanical stress along the dicing path 104 to be reduced due to the first set of laser spots 402A being cooled. In one embodiment, which can be combined with other embodiments described herein, the cooling time between each subsequent pass is between about 200 ps and about 5 ms.

At operation 304, as shown in FIG. 4C, a third set of laser spots 402C are formed on the dicing path 104. The third set of laser spots 402C are formed during a third pass by the laser 206. The operation 304 is performed based on the input parameters and the output parameters. The distance between adjacent laser spots of the first set of laser spots 402A, the second set of laser spots 402B, and the third set of laser spots 402C is between about 0.5 times and about 1.0 times the value of the laser spot diameter. The pitch 404 between adjacent laser spots of the third set of laser spots 402C is between about 3 times and about 10 times greater than the value of the laser spot diameter.

The third set of laser spots 402B are formed along the dicing path 104 and are allowed to cool, thus reducing the thermal stress surrounding the first set of laser spots 402A, the second set of laser spots 402B, and the third set of laser spots 402C. The cooling time between the second pass and the third pass allows the mechanical stress along the dicing path 104 to be reduced due to the first set of laser spots 402A and the second set of laser spots 402B being cooled.

At operation 305, a stress is provided to remove the optical device 102 from the substrate 100. The stress breaks the optical device 102 free from the substrate 100. In one embodiment, which can be combined with other embodiments described herein, the stress is mechanical stress utilized to remove the optical device 102 from the substrate 100. For example, the optical device is punched out from the substrate 100. In another embodiment, which can be combined with other embodiments described herein, the stress is a thermal stress utilized to remove the optical device 102, such as by utilizing thermal expansion. In other embodiments, it is contemplated that the optical device 102 does not require stress to be removed from the substrate 100. For example, if the laser spots 402 completely remove surround the dicing path 104, a stress is not needed to remove the optical device 102, as the optical device 102 is already free of the substrate 100.

Although only three passes are utilized in the method 300, more or less than three passes may be utilized to dice the one or more optical devices 102. For example, based on the output parameters, the number of passes is determined by the software applications and thus may be utilized to obtain the predetermined pitch 404 between the plurality of laser spots 402. Therefore, non-symmetrical stress distributions in the substrate leading to cracks or chips may be reduced. Additionally, the number of the plurality of laser spots 402 may be adjusted based on the predetermined pitch 404, the dicing speed, the laser pulse frequency, and the contour of the one or more optical devices 102. For example, more than 3 sets of laser spots 402, such as 10 sets of laser spots 402 may be formed along the dicing path 104.

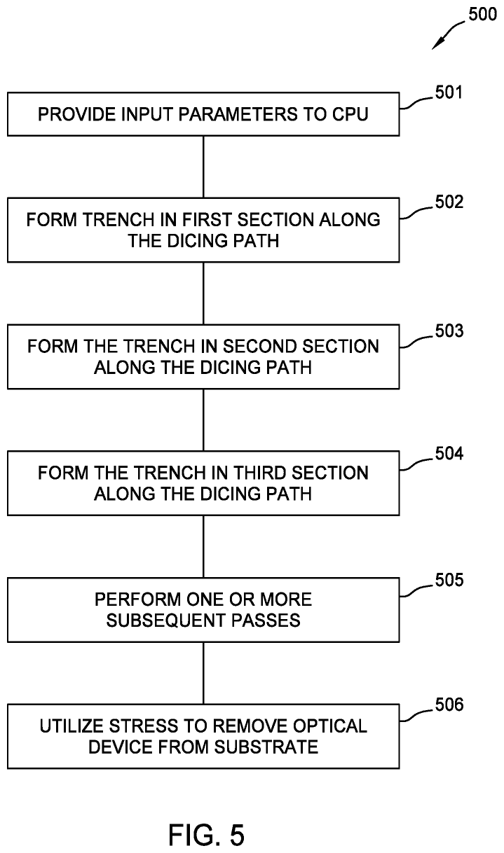

FIG. 5 is a flow diagram of a method 500 for dicing one or more optical devices 102 from a substrate 100. The method 500 is described with reference to FIGS. 6A and 6B. To facilitate explanation, the method 500 will be described with reference to the laser machining system 200 of FIG. 2. However, it is contemplated that other suitably configured apparatuses other than the laser machining system 200 may be utilized in conjunction with method 500. The method 500 utilizes a laser ablation process to dice the one or more optical devices 102 of the substrate 100. It is also contemplated that any suitable contour of the optical device 102 may be utilized with the method 500 and is not limited to the contour shown in FIG. 6A. During the method 500, a pass is defined as the laser 206 completely passing over the length of a dicing path 104. The method 500 is operable to be performed on the substrate 100 including a silicon carbide material. FIG. 6A is a schematic, top-view of an optical device 102 of one or more optical devices 102. FIG. 6B is a schematic, cross-sectional view of an optical device 102 of one or more optical devices 102.

FIGS. 6A and 6B include an optical device 102. The optical device 102 is divided into a plurality of sections 602 along the dicing path 104. A plurality of trenches 604 are etched into the substrate 100 along the dicing path 104 with a laser 206 during the method 500. The dicing path 104 surrounds the optical device 102 disposed on the substrate 100. The plurality of trenches 604 are formed along the dicing path 104 such that a thermal and/or mechanical stress field is formed around each trench 604. As shown in FIG. 6B, the plurality of trenches 604 may be formed at a plurality of trench depths 606. For example, the plurality of trenches 604 may include a first trench depth 606A and a second trench depth 606B. In one embodiment, which can be combined with other embodiments described herein, the plurality of trench depths 606 form the total trench depth 608 of the plurality of trenches 604. The plurality of trench depths 606 are not limited to each being the same trench depth. For example, the first trench depth 606A may be different from the second trench depth 606B. When the total trench depth 608 is reached, the optical device 102 may be diced from the substrate 100. Although only a first trench depth 606A and a second trench depth 606B are shown in FIG. 4B, the plurality of trench depths 606 may include one or more trench depths 606A, 606B . . . 606N to form the total trench depth 608 in conjunction with the method 500.

At operation 501, a user may provide input parameters of methods for dicing one or more optical devices 102 from the substrate 100 into a CPU in communication with a controller 208. The CPU can be a hardware unit or combination of hardware units capable of executing software applications. The input parameters include one or more of a beam width, number of pulses, pulse to pulse frequency, burst to burst frequency, a stage scanning rate, a pulse width, the contour of the one or more optical devices 102, the plurality of trench depths 606, dicing speed, or other relevant parameters. The controller 208 will provide output parameters including one or more of dicing speed, number of passes, number of the plurality of sections 602 along the dicing path 104, burst to burst frequency, pulse to pulse frequency, or other relevant parameters to be used in the method 500. The output parameters are determined based on the input parameters. The input parameters and the output parameters are utilized in the method 500 to reduce cracking and chipping of the one or more optical devices 102 during the method 500 and to optimize the stress distribution of the plurality of trenches 604. Laser power and laser spot size may also be adjusted as needed.

In one embodiment, which can be combined with other embodiments described herein, the contour of the one or more optical devices 102, the laser pulse frequency, and the plurality of trench depths 606 are input as input parameters. The software application provides output parameters including the dicing speed, the number of the plurality of sections 602, and number of passes. In another embodiment, which can be combined with other embodiments described herein, the contour of the one or more optical devices 102, the dicing speed, and the plurality of trench depths 606 are input as input parameters. The software application provides output parameters including laser pulse frequency, the number of the plurality of sections 602 along the dicing path 104, and the number of passes.

At operation 502, as shown in FIG. 6A, a trench 604 is formed in a first section 602A on the dicing path 104. The trench 604 is formed with a laser 206 of a laser machining system 200. The trench 604 of the first section 602A is at a first trench depth 606A. The first trench depth 606A is formed during a first pass by the laser 206 along the dicing path 104. The laser 206 may use a constant pulse frequency or bursts of pulses to form the trench 604. The first trench depth 606A is between about 5 μm and about 20 μm.

The operation 502 is performed based on the input parameters and the output parameters. In embodiments where the laser 206 is a Gaussian-type beam profile, the laser 206 has a beam width of between about 10 μm and about 100 μm. For example, between about 30 μm and about 60 μm. When the laser 206 utilizes burst of pulses during the formation of each laser spot 402, the number of laser pulses within a burst is between about 2 and about 1000. For example, the number of laser pulses within a burst is between about 10 and about 100. The pulse to pulse frequency of the laser 206 is between about 50 MHz and about 3 GHz. For example, between about 500 MHz and about 1 GHz. The burst to burst frequency of the laser 206 is between about 100 kHz and about 1 MHz. For example, between about 200 kHz and about 500 kHz. The scanner 204 is scanned at a rate of between about 0 m/s and about 10 m/s. For example, between about 1 m/s to about 5 m/s. The laser 206 may be in a fixed position. The laser 206 may have a pulse width of between about 100 fs and about 100 ps. For example, between about 500 fs and about 10 ps. The laser 206 may be an infrared laser. The wavelength of the laser 206 may be 1 μm. The laser 206 may be a Green laser with a wavelength between about 500 nm and about 540 nm. The laser 206 may have a dicing speed of between about 10 mm/s to about 1 m/s. For example, between 50 mm/s to about 500 mm/s. The laser 206 may have a dicing speed of between about 2 m/s to about 5 m/s. The laser 206 may have laser power between about 50 W and about 150 W.

At operation 503, as shown in FIG. 6A, a trench 604 is formed in a second section 602B on the dicing path 104. The trench 604 of the second section 602B is at a first trench depth 606A. The operation 503 is performed based on the input parameters and the output parameters. The first trench depth 606A is between about 5 μm and about 20 μm. The trench 604 of the second section 602B is formed along the dicing path 104 and is allowed to cool, thus reducing the thermal stress surrounding the second section 602B. As the trench 604 of the first section 602A is cooled in operation 502, non-symmetrical stress distributions in the substrate 100 leading to cracks or chips are reduced.

At operation 504, as shown in FIG. 6A, a trench 604 is formed in a third section 602C on the dicing path 104. The trench 604 of the third section 602C is at a first trench depth 606A. The operation 504 is performed based on the input parameters and the output parameters. The first trench depth 606A is between about 5 μm and about 20 μm. The trench 604 of the third section 602C is formed along the dicing path 104 and is allowed to cool, thus reducing the thermal stress surrounding the third section 602C. As the trench 604 of the first section 602A and the second section 602B are cooled in operations 502 and 503, non-symmetrical stress distributions in the substrate 100 leading to cracks or chips are reduced.

At operation 505, one or more subsequent passes are performed. A second pass is performed such that the trench 604 is at a second trench depth 606B in the first section 602A, the second section 602B, and the third section 602C. The second trench depth 606B is formed during the second pass by the laser 206 along the dicing path 104. Additional subsequent passes may be performed to form the trench 604 at subsequent trench depths 606B . . . 606N until a total trench depth 608 is reached in the first section 602A, the second section 602B, and the third section 602C.

In one embodiment, which can be combined with other embodiments described herein, the subsequent trench depths 606B . . . 606N are different from the first trench depth 606A. In another embodiment, which can be combined with other embodiments described herein, the subsequent trench depths 606B . . . 606N are equal to or substantially equal to the first trench depth 606A.

At operation 506, the optical device 102 is removed from the substrate 100. When the total trench depth 608 is reached, the optical device 102 is able to be removed from the substrate 100. The trench 604 is formed along the dicing path 104 and thus physically separates the optical device 102 from the substrate 100.

Although only a first trench depth 606A and a second trench depth 606B form the total trench depth 608, more or less than two trench depths may be utilized to form the total trench depth 608. Although only three passes are utilized in the method 500, more or less than three passes may be utilized to dice the one or more optical devices 102. For example, based on the output parameters, the number of passes is determined by the software applications and thus may be utilized to obtain the number of the plurality of sections 602 along the dicing path 104. Therefore, non-symmetrical stress distributions in the substrate leading to cracks or chips may be reduced. Additionally, although only three sections of the plurality of sections 602 are shown, the software application will provide output parameters to determine the number of the plurality of sections 602 to be formed by the laser 206.

In summation, embodiments described herein provide methods for dicing one or more optical devices from a substrate with a laser machining system. The laser machining system utilizes a laser to perform methods for dicing one or more optical devices from a substrate along a dicing path. The methods described herein reduce the occurrence of non-symmetrical stress distributions in the substrate which lead to cracks or chips by optimizing the laser spot distribution and trench distribution when dicing the one or more optical devices. The optimization reduces and redistributes thermal and mechanical stresses along the dicing path. The methods described herein improves the quality of the dicing by reducing the occurrence of cracks and chips, especially with the complex contours utilized with optical devices. Additionally, the quality of the one or more optical devices will improve and thus the yield of optical devices improves.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
forming a first set of laser spots along a dicing path on a first pass of a laser, the dicing path disposed around an optical device on a substrate;
forming a second set of laser spots along the dicing path on a second pass with the laser, the second set of laser spots formed adjacent to the first set of laser spots;
forming a third set of laser spots along the dicing path on a third pass with the laser, the third set of laser spots formed adjacent to the first set of laser spots and the second set of laser spots; and
removing the optical device from the substrate.

2. The method of claim 1, wherein the forming the first set of laser spots, the second set of laser spots, and the third set of laser spots includes scanning a stage with the substrate disposed thereon such that the laser moves along the dicing path.

3. The method of claim 2, wherein input parameters are provided to a controller, the controller providing the input parameters to the stage, the input parameters including one or more of a laser spot diameter, a stage scanning rate, a pulse width, a wavelength of the laser, a contour of the optical device, a laser pulse frequency, a pitch in the first pass, the second pass, or the second pass, and a dicing speed.

4. The method of claim 3, wherein the input parameters are a laser spot diameter, a stage scanning rate, a contour of the optical device, a pitch in the first pass, the second pass, and the second pass.

5. The method of claim 3, wherein the controller provides output parameters based on the input parameters to the stage, the output parameters including one or more of the dicing speed, number of passes, or the laser pulse frequency.

6. The method of claim 1, wherein the first set of laser spots, the second set of laser spots, and the third set of laser spots have a pitch between adjacent laser spots of between about 3 times and about 10 times greater than a laser spot diameter.

7. The method of claim 1, wherein the laser utilizes a burst of pulses to form the first set of laser spots, the second set of laser spots, and the third set of laser spots.

8. The method of claim 1, wherein a cooling time between each subsequent pass is between about 200 μs and about 5 ms.

9. The method of claim 1, wherein the laser moves along the dicing path with a laser pulse frequency of about 100 kHz to about 1 GHz.

10. A method, comprising:
forming a trench in a first section, a second section, and a third section at a first trench depth, the first trench depth formed during a first pass of a laser over a dicing path, the dicing path disposed around an optical device on a substrate;
performing one or more subsequent passes of the laser over the dicing path to form the trench in the first section, the second section, and the second section at subsequent trench depths until a total trench depth is reached; and
removing the optical device from the substrate.

11. The method of claim 10, wherein the forming the trench in the first section, the second section, and the third section includes scanning a scanner and a stage with the substrate disposed thereon such that the laser moves along the dicing path.

12. The method of claim 11, wherein the scanning the scanner and the stage with the substrate disposed thereon includes the laser being in a fixed position.

13. The method of claim 12, wherein input parameters are provided to a controller, the controller providing the input parameters to the stage and the scanner, the input parameters including one or more of a beam width, a number of pulses, a pulse to pulse frequency, a burst to burst frequency, a stage scanning rate, a pulse width, a contour of the optical device, the total trench depth, and a dicing speed.

14. The method of claim 13, wherein the controller provides output parameters based on the input parameters to the stage and the scanner, the output parameters including one or more of the pulse to pulse frequency, the burst to burst frequency, a number of sections along the dicing path, and a number of passes along the dicing path.

15. The method of claim 10, wherein the subsequent trench depths are different from the first trench depth.

16. The method of claim 10, wherein the subsequent trench depths are equal to or substantially equal to the first trench depth.

17. The method of claim 10, wherein the forming the trench in the first section, the second section, and the third section includes scanning a stage and a scanner such that the laser moves along the dicing path.

18. The method of claim 10, wherein the laser utilizes a burst of pulses to form the trench.

19. The method of claim 18, wherein the burst of pulses includes between about 2 and about 1000 pulses.

20. A non-transitory computer-readable medium storing instructions that, when executed by a processor, cause a computer system to perform the steps of:
forming a first set of laser spots along a dicing path on a first pass of a laser, the dicing path disposed around an optical device on a substrate;
forming a second set of laser spots along the dicing path on a second pass with the laser, the second set of laser spots formed adjacent to the first set of laser spots;
forming a third set of laser spots along the dicing path on a third pass with the laser, the third set of laser spots formed adjacent to the first set of laser spots and the second set of laser spots; and
removing the optical device from the substrate.
